(19) United States
(12) Patent Application Publication
(10) Pub. No.: US 2019/0060961 A1
(43) Pub. Date: Feb. 28, 2019

(54) INTELLIGENT HUB CLEANING DEVICE

(71) Applicant: CITIC Dicastal CO.,LTD., Qinhuangdao (CN)

(72) Inventors: Ruixiao Zhou, Qinhuangdao (CN); Zhiyuan Yu, Qinhuangdao (CN); Minghua Liu, Qinhuangdao (CN)

(21) Appl. No.: 15/797,406

(22) Filed: Oct. 30, 2017

(30) Foreign Application Priority Data
Aug. 28, 2017 (CN) 201710752758.4

(51) Int. Cl. B08B 3/02; B08B 13/00

(52) U.S. Cl. CPC B08B 3/02; B08B 13/00

(57) ABSTRACT

Disclosed is a hub cleaning device, including a base (1), a mounting transition plate (2), a water spraying module (3), hub conveying modules (4) and a work fixture (5), in which the water spraying module (3) is connected onto the mounting transition plate (2), and the mounting transition plate (2) is fixed on the base (1); the work fixture (5) is arranged at a position parallel to the base (1), so that the water spraying module (3) can face the front side of a hub (6); and the hub conveying modules (4) are arranged on two sides of the work fixture (5). The device is simple in structure, and eliminates cleaning dead angles. One device can complete cleaning of multiple types of hubs, thereby greatly reducing the input of enterprises on cleaning devices.

### CROSS-REFERENCE TO RELATED APPLICATIONS

This application is filed based upon and claims priority to Chinese Patent Application No. 201710752758.4, filed on Aug. 28, 2017, the entire contents of which are incorporated herein by reference.

### BACKGROUND

The cleaning procedure is an important procedure in the production process of an aluminum alloy hub. The existing hub cleaning methods roughly can be divided into manual, brush and high pressure nozzle ones. The manual cleaning method is low in degree of automation, low in efficiency and severe in working environment, and is thus not suitable for large batch production. In the process of cleaning a hub by a brush-type cleaning machine, the cleaning of the hub is not simple plane cleaning, the central height of the hub of each vehicle type is different, and the placing angles and positions when wheels are cleaned are slightly different, so cleaning dead angles exist in the conventional cleaning process and are difficult to clean, and harmful effects are produced on follow-up coating. The brush cleaning method cannot realize automatic centering and then cannot effectively clean a hub, and it cannot adapt to cleaning hubs of different vehicle types. Although the high pressure nozzle method can be used for cleaning hubs in various shapes, the cleaning area of a single nozzle is small, and a plurality of nozzles are needed to improve the cleaning efficiency, resulting in increase of the cost. Therefore, a device which can adapt to cleaning of different types of hubs and is relatively low in cost in the disclosure has very positive practical significance.

### SUMMARY

The disclosure relates to the technical fields of aluminum alloy casting and machining, and specifically relates to a hub cleaning device.

The disclosure is aimed at providing a hub cleaning device, thus overcoming the defects that the traditional hub cleaning methods cannot realize cleaning of multiple types of hubs, have cleaning dead angles, are relatively high in cost and the like.

A hub cleaning device includes a base, a mounting transition plate, a water spraying module, hub conveying modules and a work fixture.

The water spraying module is connected onto the mounting transition plate by bolt connection, and the mounting transition plate is fixed on the base by bolt connection. The work fixture is arranged at a position parallel to the base, so that the water spraying module can face the front side of a hub. The hub conveying modules are arranged on two sides of the work fixture.

The water spraying module includes a fixed platform, hooke joints, drive rods, sliding rods, ball joints, displacement sensors, high pressure nozzles, a movable platform and water pipes. The water spraying module is characterized in that the fixed platform is connected onto the mounting transition plate by bolt connection. The hooke joints are connected onto the fixed platform by bolt connection. The drive rod is fixed on the shaft of the hooke joint. One end of the sliding rod and the drive rod form a sliding pair, and the other end of the sliding rod is fixedly connected with the ball joint. The ball joints are connected with the movable platform by bolt connection. The high pressure nozzles and the displacement sensors are arranged on the movable platform. The displacement sensors are arranged nearby the high pressure nozzles. The water pipes communicate with the high pressure nozzles to provide high pressure water for the high pressure nozzles.

The hooke joint, the drive rod, the sliding rod and the ball joint form a supporting leg. A plurality of such supporting legs, the fixed platform and the movable platform form a parallel adjustable platform, and relative to a series adjustable platform, the parallel adjustable platform is higher in rigidity, higher in precision and more flexible in motion. Generally, the quantity of the supporting legs is three to six. In an embodiment, three supporting legs may be used in the disclosure to form a UPS six degree of freedom parallel platform, thus reducing the cost.

The work fixture includes a support frame, V-shaped blocks, a baffle, a pressure block, a threaded rod, a water fender and a handle. The work fixture is characterized in that the V-shaped blocks are arranged on the support frame and in two columns, and are used for center positioning on rims of two sides of the hub. The baffle is arranged on one side of the V-shaped blocks, and the pressure block is arranged on the other side of the V-shaped blocks and used for fixing the hub. The pressure block is adjusted via the handle, the threaded rod is fixed with the pressure block and the handle and connected with a threaded hole in the support frame by threaded connection, and thus, the pressure block can be adjusted by rotating the handle to clamp hubs of different types.

When the hub of a different type is conveyed to the work fixture by the hub conveying modules, the hub is positioned by the V-shaped blocks, and then the pressure block clamps the hub by tightening the handle. At the moment, the positions of the high pressure nozzles can be adjusted in real time via the water spraying module, so that they can adapt to different types of hubs. The displacement sensors arranged on the movable platform can feed back the distance between the high pressure nozzles and the surface of the opposite object in real time. When the distance value is within a given range, the front sides of the high pressure nozzles face the surface of the hub, and the surface needs to be cleaned. When the distance value is beyond the given range, the front sides of the high pressure nozzles do not face the surface of the hub, cleaning is not needed, and then the position and posture of the movable platform are adjusted by controlling the extensions of the drive rods, till the high pressure nozzles face the surface of the hub. Thus, a closed loop control is formed, and the surface that needs to be cleaned can be automatically sought. In addition, the adjusting range of the water spraying module is set according to the maximum size of different types of hubs to be cleaned, and thus, one hub cleaning device can realize the function of cleaning different types of hubs.

The disclosure is simple in structure and convenient to operate, and eliminates cleaning dead angles. One device can complete cleaning of multiple types of hubs, thereby greatly reducing the input of enterprises on cleaning devices and saving a lot of money for the enterprises. In addition, the disclosure is high in degree of intelligence, and can automatically seek the hub surface that needs to be cleaned, thereby avoiding time and cleaner waste on the surface that does not need to be cleaned, further improving the production efficiency and reducing the cost.

### BRIEF DESCRIPTION OF THE DRAWINGS

The implementation scheme of the disclosure will be described in detail below in combination with the accompanying drawings.

FIG. 1 is a structural schematic diagram of a hub cleaning device.

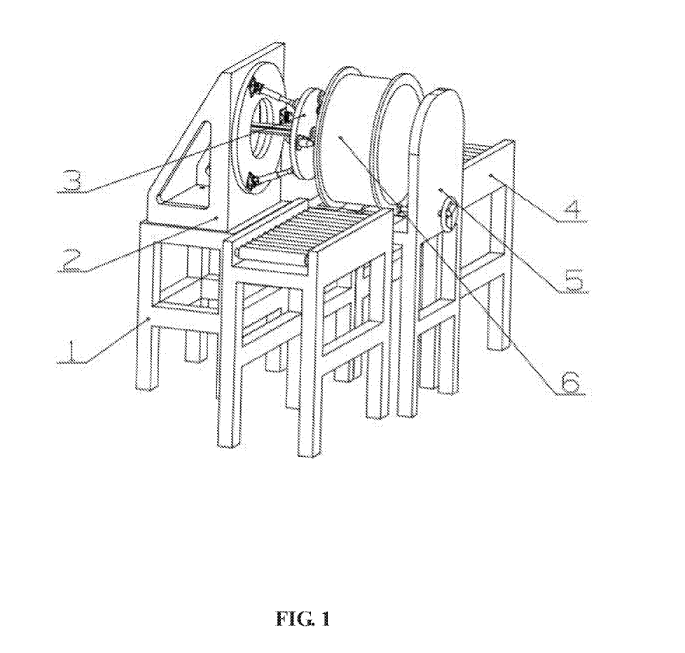

FIG. 2 is a structural schematic diagram of a water spraying module of the disclosure.

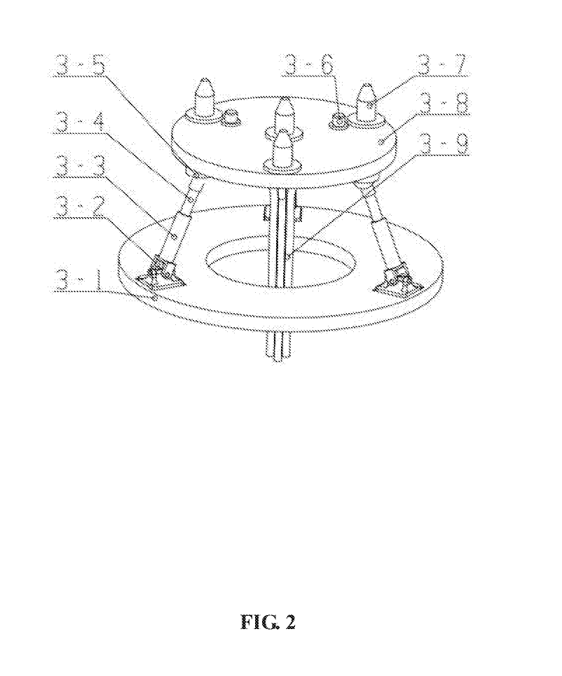

FIG. 3 is a structural schematic diagram of a work fixture of the disclosure.

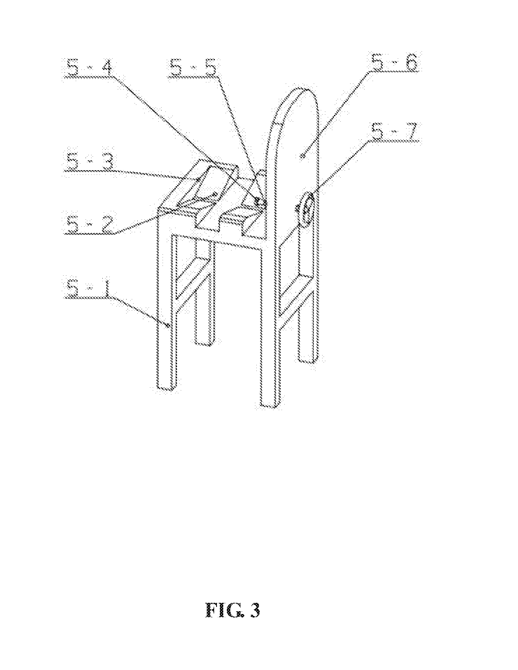

In which, 1—base, 2—mounting transition plate, 3—water spraying module, 4—hub conveying module, 5—work fixture, 6—hub, 3-1—fixed platform, 3-2—hooke joint, 3-3—drive rod, 3-4—sliding rod, 3-5—ball joint, 3-6—displacement sensor, 3-7—high pressure nozzle, 3-8—movable platform, 3-9—water pipe, 5-1—support frame, 5-2—V-shaped block, 5-3—baffle, 5-4—pressure block, 5-5—threaded rod, 5-6—water fender, 5-7—handle.

### DETAILED DESCRIPTION

### Embodiment 1

This embodiment discloses a hub cleaning device. The device includes a base 1, a mounting transition plate 2, a water spraying module 3, hub conveying modules 4 and a work fixture 5.

The water spraying module 3 is connected onto the mounting transition plate 2 by bolt connection, and the mounting transition plate 2 is fixed on the base 1 by bolt connection. The work fixture 5 is arranged at a position parallel to the base 1, so that the water spraying module 3 can face the front side of a hub 6. The hub conveying modules 4 are arranged on two sides of the work fixture 5.

The water spraying module 3 includes a fixed platform 3-1, hooke joints 3-2, drive rods 3-3, sliding rods 3-4, ball joints 3-5, displacement sensors 3-6, high pressure nozzles 3-7, a movable platform 3-8 and water pipes 3-9. The water spraying module 3 is characterized in that the fixed platform 3-1 is connected onto the mounting transition plate 2 by bolt connection. The hooke joints 3-2 are connected onto the fixed platform 3-1 by bolt connection. The drive rod 3-3 is fixed on the shaft of the hooke joint 3-2. One end of the sliding rod 3-4 and the drive rod 3-3 form a sliding pair, and the other end of the sliding rod 3-4 is fixedly connected with the ball joint 3-5. The ball joints 3-5 are connected with the movable platform 3-8 by bolt connection. The high pressure nozzles 3-7 and the displacement sensors 3-6 are arranged on the movable platform 3-8. The displacement sensors 3-6 are arranged nearby the high pressure nozzles 3-7. The water pipes 3-9 communicate with the high pressure nozzles 3-7 to provide high pressure water for the high pressure nozzles 3-7.

The hooke joint 3-2, the drive rod 3-3, the sliding rod 3-4 and the ball joint 3-5 form a supporting leg. A plurality of such supporting legs, the fixed platform 3-1 and the movable platform 3-8 form a parallel adjustable platform, and relative to a series adjustable platform, the parallel adjustable platform is higher in rigidity, higher in precision and more flexible in motion. Generally, the quantity of the supporting legs is three to six. In an embodiment, three supporting legs may be used in the disclosure to form a 3-UPS six-degree-of-freedom parallel platform, thus reducing the cost.

The work fixture 5 includes a support frame 5-1, V-shaped blocks 5-2, a baffle 5-3, a pressure block 5-4, a threaded rod 5-5, a water fender 5-6 and a handle 5-7. The work fixture 5 is characterized in that the V-shaped blocks 5-2 are arranged on the support frame 5-1 and in two columns, and are used for center positioning on rims of two sides of the hub 6. The baffle 5-3 is arranged on one side of the V-shaped blocks 5-2, and the pressure block 5-4 is arranged on the other side of the V-shaped blocks 5-2 and used for fixing the hub 6. The pressure block 5-4 is adjusted via the handle 5-7, the threaded rod 5-5 is fixed with the pressure block 5-4 and the handle 5-7 and connected with a threaded hole in the support frame 5-1 by threaded connection, thus, the pressure block 5-4 can be adjusted by rotating the handle 5-7 to clamp hubs 6 of different types.

When the hub 6 of a different type is conveyed to the work fixture 5 by the hub conveying modules 4, the hub 6 is positioned by the V-shaped blocks 5-2, and then the pressure block 5-4 clamps the hub 6 by tightening the handle 5-7. At the moment, the positions of the high pressure nozzles 3-7 can be adjusted in real time via the water spraying module 3, so that they can adapt to different types of hubs 6. The displacement sensors 3-6 arranged on the movable platform 3-8 can feed back the distance between the high pressure nozzles 3-7 and the surface of the opposite object in real time. When the distance value is within a given range, the front sides of the high pressure nozzles face the surface of the hub 6, and the surface needs to be cleaned. When the distance value is beyond the given range, the front sides of the high pressure nozzles 3-7 do not face the surface of the hub 6, cleaning is not needed, and then the position and posture of the movable platform 3-8 are adjusted by controlling the extensions of the drive rods 3-3, till the high pressure nozzles 3-7 face the surface of the hub 6. Thus, a closed-loop control is formed, and the surface that needs to be cleaned can be automatically sought. In addition, the adjusting range of the water spraying module 3 is set according to the maximum size of different types of hubs 6 to be cleaned, and thus, one hub cleaning device can realize the function of cleaning different types of hubs.

Described above is merely a preferred embodiment of the disclosure. Changes may be made to the specific embodiment and the application scope for those of ordinary skill in the art according to the thought of the disclosure. The content of the specification should not be understood as limiting the disclosure.

1. A hub cleaning device, including a base, a mounting transition plate, a water spraying module, hub conveying modules and a work fixture, wherein the water spraying module is connected onto the mounting transition plate, and the mounting transition plate is fixed on the base; the work fixture is arranged at such a position that the water spraying module can face a front side of a hub; one or more of the hub conveying modules are arranged on either side of the work fixture;
the water spraying module includes a fixed platform, hooke joints, drive rods, sliding rods, ball joints, displacement sensors, high pressure nozzles, a movable platform and water pipes; the fixed platform is connected onto the mounting transition plate; the hooke joints are connected onto the fixed platform; the drive rods are fixed on a shaft of the hooke joints; one end of the sliding rods and the drive rods form a sliding pair, and the other end of the sliding rods are fixedly connected with the ball joints; the ball joints are connected with the movable platform; the high pressure nozzles and the displacement sensors are arranged on the movable platform; the displacement sensors are arranged nearby the high pressure nozzles; each of the water pipes communicate with each of the high pressure nozzles, respectively;
the hooke joints, the drive rods, the sliding rods and the ball joints form supporting legs; the supporting legs, the fixed platform and the movable platform form a parallel adjustable platform, and a quantity of the supporting legs is three to six;
the work fixture includes a support frame, V-shaped blocks, a baffle, a pressure block, a threaded rod, a water fender and a handle; the V-shaped blocks are arranged on the support frame and in two columns, and in each of the two columns there is provided one V-shaped block; the baffle is arranged on one side of the V-shaped blocks, and the pressure block is arranged on the other side of the V-shaped blocks; the pressure block is adjusted via the handle, the threaded rod is fixed with the pressure block and the handle and connected with a threaded hole in the support frame, and thus, the pressure block can be adjusted by rotating the handle to clamp hubs of different types.

2. The hub cleaning device of claim 1, in which the quantity of the supporting legs formed by the sliding rods and the ball joints is three, and a 3-UPS six-degree-of-freedom parallel platform is thus formed.
